(19) United States
(12) Patent Application Publication
(10) Pub. No.: US 2026/0166700 A1
(43) Pub. Date: Jun. 18, 2026

(54) LINEAR ACTOR WITH OPTIMIZED INDUCTIVITY AND METHOD OF WINDING AND CONNECTING COILS

(71) Applicant: TECHNISCHE UNIVERSITAET WIEN, Wien (AT)

(72) Inventors: Stephan KRALL, Wien (AT); Thomas WEILER, Wien (AT); David JAUNECKER, Wien (AT); Helmut CAUDR, Wien (AT); Friedrich BLEICHER, Wien (AT)

(21) Appl. No.: 18/994,927

(22) PCT Filed: Jul. 12, 2023
(86) PCT No.: PCT/EP2023/069372

§ 371 Date: Jan. 15, 2025

(30) Foreign Application Priority Data
Jul. 15, 2022 (DE) 10 2022 117 759.9

(51) Int. Cl. B25D 9/04; F01L 9/20; F15B 13/042; F16H 25/20; H02K 41/02

(52) U.S. Cl. CPC B25D 9/04; F01L 9/20; F15B 13/042; F16H 25/2015; F16H 2025/2078; H02K 41/02

(57) ABSTRACT

A linear reluctance actor is provided comprising a stator supporting at least one coil and a rotor. The coil is designed as a bifilar winding and the linear actor includes at least one resetting element allowing the rotor to be brought into a predefined initial position after a stroke movement.

### Background

The invention relates to a linear reluctance actor and to tools and/or drives designed with a linear actor of this type.

A tool of this type for machine hammer peening (MHP) is usually chucked into a machine tool or a robot so that the workpiece to be machined is machined by a plurality of individual precisely sequenced blows from a usually spherical tool tip. Accordingly, the contact between the tool tip and the tool surface can be continuous or periodical. When a commonly used carbide tip is periodically applied to a workpiece surface, the tool is oscillated by a linear actor at a defined stroke frequency, stroke amplitude and zero crossing. This oscillating movement of the tool, also referred to as ram, can be accomplished by different actor principles.

Linear actors can be basically grouped into different categories according to the mode of action thereof, the travel path of the rotor and the design.

Linear actors which operate predominantly mechanically are described, for example, in the documents DE 20 2015 000 360 U1 , WO 2016 136 169 A1 , DE 10 2014 107 173 A1 , DE 10 2016 000 389 A1 , DE 20 2015 003 249 U1 , EP 2 851 441 A2 , EP 2 851 442 A1 and US 2014 000 7 394 A1 .

The tools described in the documents DE 10 2009 041 720 A1 and DE 20 2013 002 473 U1 make use of a piezoelectric linear drive.

Pneumatic or coolant-operated/lubricant-operated tools are the subject matter of the documents DE 10 2012 103 111 A1 and DE 20 2009 001 619 U1 .

Tools which are directly/indirectly controlled by sonotrodes are disclosed in the documents U.S. Pat. No. 6,932,876 B1 , US 2007 024 4 595 A, US 2015 011 4 074 A and WO 2004 028 739 A1 .

In electric drives as described, for example, in the documents DE 10 2006 033 004 A1 and U.S. Pat. No. 4,641,510 A, it is discriminated between the types of reaction forces in response to the active principle. Linear actors operating according to the electrodynamic principle (such as the plunger coil principle) show substantial drawbacks in the field of dynamics and power development due to the unfavorable mass distribution of the mechanical structure. In addition, the mechanically highly loaded coils used in those systems and a low power density are detrimental to a highly dynamic motion sequence.

Apart from the above-described linear drives, also linear reluctance actors are known in which an axially adjustable rotor/actor is guided in a stator, the stroke of the rotor/actor being generated by the reluctance force. The mode of action of those linear actors is described, for example, in the documents “Identification of Some Tubular Topologies of Linear Switched Reluctance Generator for Direct Drive Applications in Oceans Wave Energy Conversion”; R. P. G. Mendes, R. M. R. A. Calado, S. J. P. S. Mariano; Proceedings of the World Congress on Engineering 2014, Vol. 1, WCE 2014, Jul. 2-4, 2014, London, U.K., and “Analysis and Modelling of Linear-Switched Reluctance for Medical Application”, Jean-Francois Llibre, Nicolas Martinez, Pascal Leprinc, Bertrand Nogarede; Actuators 2013, 2, 27-44 (www.mdpi.com/journal/actuators).

In the document WO 2017/129 249 A1 , a multi-phase linear reluctance reactor is described in which a tubular stator having a modular structure includes a plurality of coils axially positioned one behind the other which are accommodated in recesses delimited by radial webs. In said stator, a rotor is guided to be axially movable which, in this embodiment, includes on its outer periphery plural annular permanent magnets each being inserted in an annular groove.

Corresponding linear reluctance actors are also described in the documents DE 44 07 385 A1, DE 43 11 664 A1 and WO 85/05507 A1. All those systems are designed for comparatively large strokes so that a multi-phase control is provided and permanent magnets are provided on the stator or rotor.

In the patent application DE 29 31 685 A1, linear reluctance actors are described in which a stator has a conical design and along its outer periphery includes annular grooves whose groove diameter varies depending on the conification. A winding of one single wire is inserted into said grooves, wherein the turns of said winding are oriented in opposite directions in adjacent grooves so that electric current passed through said winding has an opposite current direction in two successive turns. Said stator is encompassed by a cup-shaped, equally conified rotor, wherein, on the inner periphery of the rotor, ribs are formed which form pairs of pole surfaces with appropriately designed ribs separating adjacent grooves from each other, an air gap that is minimized due to the reluctance force when the winding is energized being formed between said pairs of pole surfaces.

DE 10 2005 017 483 A1 describes a linear actor in which two coils wound in opposite directions are arranged one behind the other in a stator in the stroke direction, the winding axis of the coil extending transversely to the stroke direction. The two coils are arranged inside two rotor guides of the stator, with pairs of teeth being arranged on the surfaces thereof facing a rotor. The rotor movable between said pairs of teeth is U-shaped, each leg of the U being formed by a stack of permanently magnetic rods which are arranged with an air gap from the pairs of teeth so that, when energized, the rotor is adjustable in the stroke direction due to the reluctance force.

DE 44 07 385 A1 describes a flat linear reluctance actor designed for the transport of objects in the linear direction, wherein areas delimiting an air gap between the stator and the rotor are formed by a soft-magnetic material in which grooves forming the afore-described teeth are incorporated.

In EP 2 884 637 A1, a linear reluctance reactor for adjusting an optical assembly is shown in which, similarly to the above-described solutions, teeth are provided on the stator and rotor side between which an air gap is formed that is minimized due to the reluctance force, when a stator-side coil arrangement is energized, so that the rotor performs a corresponding stroke.

In WO 2019/096834 A1 to the applicant, a linear reluctance actor having a tubular stator is described on which a plurality of coils axially spaced apart from one another are arranged in a respective annular recess of an inner sheath surface of the stator. In the tubular stator, a rotor is supported to be axially adjustable and on its outer periphery includes a tooth profile that forms a respective air gap with the radial webs delimiting the recesses of the stator. In the known linear reluctance actor, the coils are activated via power electronics so that the rotor performs a regulated stroke due to the reluctance force depending on the activation. In this known linear reactor, the current of adjacent coils is designed to flow in opposite directions. The geometry of the radial webs and the tooth profile is optimized as regards the magnetic flux so that the stroke can be realized with high dynamics. The structure of said linear reluctance actor is further simplified as no permanent magnets, such as in several of the above-described solutions, are provided, where the stator and the rotor are made of a magnetically conductive material, preferably of a soft magnetic material. By said drive design, very high force densities can be achieved in a single-phase configuration.

However, it is a drawback of this solution that the structure with a plurality of coils guided on a tubular stator requires a high manufacturing effort during production and furthermore is accompanied by a considerable installation space.

Further prior art is known also from DE 2602672 A1 . That document discloses an electromagnetic device having a winding through which electric current can be passed, and comprising two relatively movable members which migrate relatively in response to the magnetic field which is generated by electric current passing through the winding. It is emphasized as a particular feature that one of the members has a generally annular shape and surrounds the other member at a distance, the other member having a substantially cylindrical peripheral surface, and each of the inner surface of the one member and the peripheral surface of the other member being provided with a double screw nut or with a screw nut having a multiple of two starts, and the grooves forming ribs on the surfaces, wherein the grooves or successive grooves on one of the members support the electric winding that is arranged so that the direction of the current flow extends in opposite directions in the parts of the winding in the grooves or in successive grooves, wherein the arrangement is such that, when electric current flows through the winding, the members move relative to each other in one direction so that the ribs are aligned with one another at the two members.

Also, U.S. Pat. No. 4,003,013 A discloses an electromagnetic device comprising a pair of relatively movable magnetizable elements the surfaces of which are arranged opposite to each other.

U.S. Pat. No. 3,353,040 A discloses a different electrodynamic transducer, whereas US 2009/0243416 A1 discloses an electric motor. Said devices originate from a different technical field, however, and are foreign to a skilled person.

A completely different linear reluctance actor is further disclosed in DE 10 2017 127 021 A1. There, a linear reluctance actor having a tubular stator is described on which a plurality of coils spaced apart from one another are arranged in a respective circumferential recess of an inner circumferential surface of the stator, wherein the recesses are axially delimited by radial webs, comprising a rotor which is supported to be axially movable and on its magnetically effective circumference facing the stator includes a tooth profile forming an air gap with each of the radial webs and being provided with power electronics for activating the coils so that, due to the reluctance force, the rotor performs a controlled/controllable stroke depending on the activation. It is emphasized as a particular feature that the tooth profile is formed complementary to the radial webs, wherein each of the latter and of the tooth profile is designed with annular grooves open toward the stator and/or the rotor, the grooves being arranged with a minimum air gap approximately radially opposite to each other, and that the stator and the rotor are made of magnetically conductive or soft magnetic material.

All of these known solutions have specific drawbacks which have to be eliminated or at least to be mitigated.

### SUMMARY

In particular, the object underlying the invention is to provide a generic linear reluctance actor which allows a highly dynamic motion sequence while having a compact design. A further object underlying the invention is to provide appropriate applications in which the optimized linear reluctance actor can be used, i.e., to present an actor that can be used properly in different applications.

The linear reluctance actor according to the invention has an axially adjustable rotor and a stator arranged coaxially thereto, and at least one coil arranged in the area between the stator and the rotor. The coil is guided in a groove of the stator which is delimited by groove webs. A groove profile facing the groove webs whose groove walls form/delimit an air gap with each of the groove webs is formed on the rotor. The linear actor is further designed with power electronics for activating the coil so that the rotor performs a variable stroke in response to said activation due to the reluctance force so that, when the at least one coil is energized, the preferably axial offset between the groove webs and the groove profile is minimized. In accordance with the invention, the stator and the rotor are made of magnetically conductive and/or soft magnetic material. In such case, the stroke corresponds approximately to the axial width of a groove web and/or a rotor web of the groove wall. The groove and/or the groove profile in the form of a double helix is designed to be double-threaded, wherein the coil is guided along a helix turn from a coil inlet to a turning point and from there is returned along the second helix turn to a coil outlet in the opposite direction, wherein the coil sections leading to and away from the turning point are arranged to be bifilar.

According to the invention, the linear actor therefore includes at least one resetting element designed so that during operation the rotor is brought into a particular predefined initial position after a stroke movement. Thus, the rotor has one resetting element or plural resetting elements, preferably in the form of return springs such as in the kind of helical springs, preferably helical compression springs, causing the rotor to be forced into a predefined initial position after a stroke movement.

This configuration according to the invention having one or more resetting elements allows for a continuous and a discrete movement (i.e., triggering one or more individual blows) of the hammer head. As the rotor can be brought into a predefined initial position, the required kinetic energy which depends on a necessary blow distance and on the material of the sample can be precisely adjusted.

Moreover, a bifilar winding can be produced by far more easily than the complex windings according to the above-described prior art, wherein particularly also the internal support of the at least one coil on the stator which is encompassed by the rotor is of advantage. In addition, the concept according to the invention can be excellently scaled as by the selection of the wire diameter of the coil, it is possible to easily adapt the axial length of the latter to different requirements. In the afore-described prior art, said scalability is not given due to the complex structure of the stator. Another advantage consists in the fact that the double-threaded double helix can be manufactured in a considerably simpler manner than the groove structure in the known solutions in which a plurality of axially spaced annular grooves having complex tooth profiles have to be manufactured.

The present system can be operated both in the controlled and in the regulated operation. The regulation relates to the movement and, thus, to the speed of the hammer head and, finally, to the deformation energy introduced to the workpiece. The simple design of the power electronics allows to predetermine the introduced energy in a defined manner by specifying the duty cycle of the coil voltage.

Via the distance measurement sensor/position sensor system used, said duty cycle can also be operated when regulated with minimum inductivity so that a target speed and, thus, also the kinetic energy can be or is constantly observed.

Preferred embodiments are claimed in the subclaims and will be illustrated in detail in the following.

In a preferred embodiment, the at least one resetting element is designed to be resilient in the direction of movement of the rotor, and/or a plurality of resetting elements are distributed along the circumference of the stator. Accordingly, it is advantageous when the resetting elements, for example 3, 4 or 5 elements, are equally distributed along the circumference and are equally radially distanced from the center. They can be designed as elastomers. All resetting elements can be equal or can be specifically selected differently. The linear actor may be provided to include at least one resetting element in the form of a return spring, preferably a plurality of resetting elements in the form of return springs. Particularly preferred, the linear actor includes a plurality of resetting elements in the form of return springs distributed along the circumference of the stator which are designed so that during operation the rotor is brought into a specific predefined initial position after a stroke movement.

In a particularly preferred embodiment, the rotor is tubular and formed on the outside so that it encompasses the stator, wherein the groove guiding the at least one coil and being designed as a double helix is formed on the outer circumferential surface of the stator and the associated groove profile equally designed as a double helix is formed on an inner circumferential surface of the rotor.

The dynamics of the linear reluctance actor can be further improved when the at least one coil is in the form of a stranded wire made of plural individual wires and/or of an exactly (pre-)defined number of individual wires. The use of individual strands permits a higher degree of filling or a higher packing density of the groove profile and, thus, higher currents in the winding. Alternatively, the coil is made of a single wire with a plurality of turns, for example with 12, 13, 14, 15 or 16 turns.

The number of windings determines the total inductivity, and, resp., the total inductivity is optimized by the (predefined) number of windings, whereby the current is limited. Thus, there is no explicit current limit and the system is regulated on its own. This ensures easy control.

Moreover, the design of the tooth geometry on the rotor and stator sides each of which is configured by the groove profiles guiding the coil is optimized such that the magnetic flux density is maximized. In particular, the tooth geometry and the tooth offset corresponding to the stroke in the case of a single-phase coil were designed with an FEMM (Finite Element Method Magnetics) simulation. For such design of the tooth geometry, a maximum flux of force was selected as a criterion of optimization to achieve high dynamics. Advantageously, the tooth geometry/geometries is/are designed so that they are tapered, preferably in trapezoidal shape, toward the web. The web width is larger than or equal to the tooth offset. This ensures both simple manufacturing and a high force density.

In one embodiment, the coil, more particularly the stranded wire, is insulated so that cooling is made possible by direct contact of the coolant with the coil.

In order to realize a stroke reversal or a longer stroke, plural coils can be connected to form a multi-phase structure, with the coils being individually activatable via the power electronics.

As explained above, a cooling can be associated with the coil to avoid excessive heat development.

Said cooling can be performed using a coolant, such as air or a cooling liquid, that is passed along the air gap and/or the stator.

The structure of the linear reluctance actor is particularly simple when the pitches and groove widths of the stator-side and rotor-side double helix have a substantially equal design.

The linear actor according to the invention can be used, for example, in a tool for machine hammer peening, wherein a mechanical interface for a hammer head is provided on the rotor.

The linear actor according to the invention can also be used, however, in other applications, for example in a valve train of an internal combustion engine and/or for actuating servo and/or directional control valves and/or for oscillation-based machining of composite materials or monolithic materials.

### BRIEF DESCRIPTION OF THE DRAWINGS

Preferred embodiments of the invention will be illustrated in detail as follows by way of schematic drawings, wherein:

FIG. 1 shows a schematic outside view of a linear reluctance actor according to the invention which is designed to drive a surface hammer;

FIG. 2 shows a schematic view of the structure of the linear actor according to FIG. 1;

FIG. 3 shows a schematic diagram of a coil of a linear actor according to FIGS. 1 and 2;

FIG. 4 shows the basic concept of a control circuit of the linear actor according to the invention;

FIG. 5 shows a representation of the linear actor corresponding to FIG. 3 in an initial position and a target position with field lines occurring when the coil is energized;

FIG. 6 shows a schematic diagram of the linear actor with plotted coolant flow paths;

FIG. 7, including FIG. 7(a) and 7(b), shows switching symbols of a linear actor used for single-phase or multi-phase operation;

FIG. 8 shows a further embodiment of a schematic lateral section view of the linear reluctance actor according to the invention that is designed to drive a surface hammer;

FIG. 9 shows an isometric front view of the linear reluctance actor according to the invention of the embodiment shown in FIG. 8;

FIG. 10 shows an isometric rear view of the linear reluctance actor according to the invention of the embodiment shown in FIG. 8 and FIG. 9; and

FIG. 11 shows a schematic functional representation of the control unit of the linear actor.

### DETAILED DESCRIPTION OF VARIOUS EMBODIMENTS

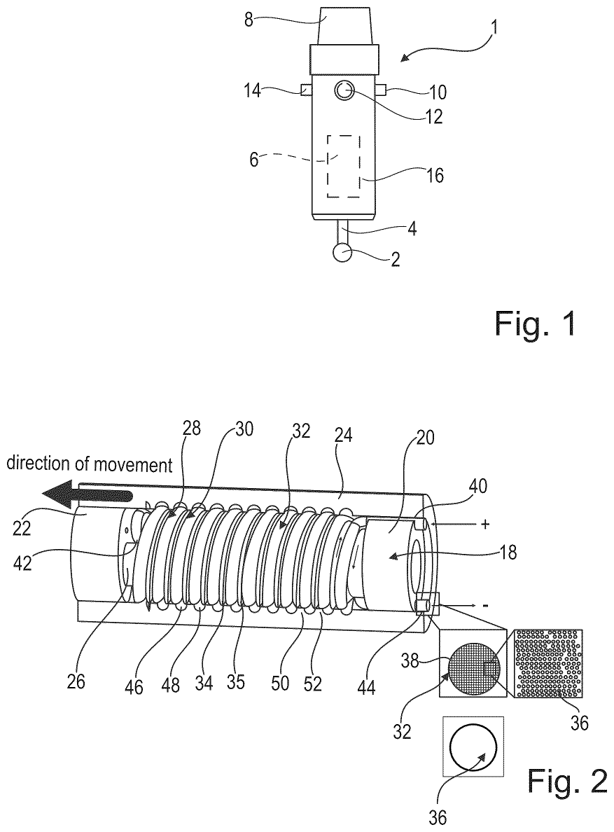

In the following, the invention will be illustrated on the basis of a forming tool for machine hammer peening, hereinafter referred to as surface hammer 1. According to FIG. 1, the latter has a hammer head 4 configured with an impact insert 2 made of hard metal or other materials which is periodically oscillated for machine hammer peening by means of a linear reluctance actor 6 according to the invention or can be kept in continuous contact with the workpiece to be machined. The surface hammer 1 further has a mechanical interface, in the present case a hollow shank taper 8 via which the surface hammer 1 can be inserted into a corresponding tool holder of a machine tool or a robot so that the surface hammer 1 is guided via the NC axes of the machine tool and/or the robot during machining.

As a matter of course, the linear reluctance actor 6—abbreviated to linear actor in the following—can also be used in other applications. Therefore, it is possible, for example, to actuate a valve train of an internal combustion engine by such a linear actor 6. The oscillation-based machining of workpieces made of ceramic materials, hard metals, glass, etc. or composite materials or other monolithic materials can also be carried out by a tool that is configured with such a linear actor 6. Also, an application in valve trains is conceivable.

A time-discrete control of the stroke of the linear actor 6 is performed via power electronics the structure of which will be discussed further below.

The reference signs 10, 12 and 14 indicate radial ports for coolant and energy supply as well as for signal transmission.

FIG. 2 illustrates the basic structure of the linear actor 6 that is accommodated in a housing 16 of the surface hammer 1. Accordingly, a stator 18 arranged coaxially to the hammer head 4 is supported in the housing 16, with bearing sections, such as plain bearing bushes 20, 22, which are supported both in the axial direction and in the radial direction in the housing 16 being formed at the two radially extended end sections of the stator. Said plain bearing bushes 20, 22 may be made of ceramic, for example. A rotor 24 is guided to be movable in the stroke direction along said plain bearing bushes 20, 22. In a variant, the bearing bushes are tightly pressed with the rotor and are part of the moved mass. Therefore, in a variant they are not axially supported.

Radially distributed guides prevent the rotor from twisting during the movement procedure. In the shown embodiment, the rotor 24 is tubular and encompasses at least partly the central stator 18. The stator 18 and the rotor 24 are made of a soft magnetic material in the shown embodiment.

On a coil holding section 26 of the stator 18 located between and radially set back against the two plain bearing bushes 20, 22, there is formed a double helix, i.e., two spiral grooves 28, 30 extending in parallel which extend along the outer circumference of the coil holding section 26 and in which a coil 32 is guided. Each of the two spiral grooves 28, 30 is delimited by groove webs 34, 35 whose radial extension is selected so that the coil turn can immerse completely into the respective groove 28, 30 and, thus, does not protrude from the outer circumference of the stator 18.

In the shown embodiment, according to the detail shown at the bottom right, the coil 32 is designed as a strand having a plurality of single wires 36 surrounded by an insulation 38 forming the outer circumference of the strand, or as a single wire 36 having plural turns.

The coil 32 or, more precisely, the strand enters through a coil inlet 40 extending axially in parallel through the plain bearing bush 20 into the area of the coil holding section 26 and then is guided along the spiral groove 28 to a turning point 42 provided in the area of the other plain bearing bush 22. The coil 32 (strand) then is deflected via said turning point 42 and is returned along the second groove 30 to a coil outlet 44. In the representation according to FIG. 2, the turns of the coil extending toward the turning point 42 are designed to have a shading different from that of the coil section returning from the turning point 42 to the coil outlet 44. This creates a kind of wire pair made of a robust insulated stranded wire which forms the wound coil.

When said coil 32 formed in a bifilar winding mode is energized, in the area of the turning point 42 the current direction is reversed. The inductivity of the winding can be reduced drastically by the bifilar winding.

As it is further shown in FIG. 2, on the inner circumferential wall of the stator 24 a double groove profile with spiral rotor grooves 46, 48 is formed whose geometry (pitch, groove width) corresponds to that of the spiral grooves 28, 30. Basically, also forms other than shown in the schematic diagram of FIG. 2 are conceivable. Rotor webs 50, 52 which virtually form the side walls of the rotor grooves 46, 48 are arranged between the spiral rotor grooves 46, 48 extending in parallel. The geometry of said rotor webs 50, 52 is designed corresponding to the geometry of the groove webs 34, 35.

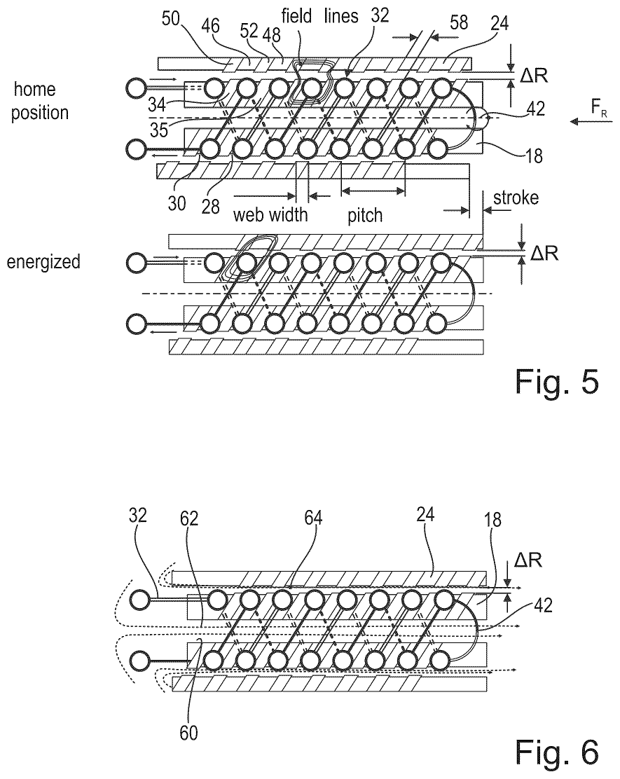

As will be explained in greater detail in the following (see FIG. 5), an axial offset 58 remains between the rotor webs 50, 52, on the one hand, and the groove webs 34, 35, on the other hand, which is minimized by the stroke movement of the rotor due to the reluctance force when energized.

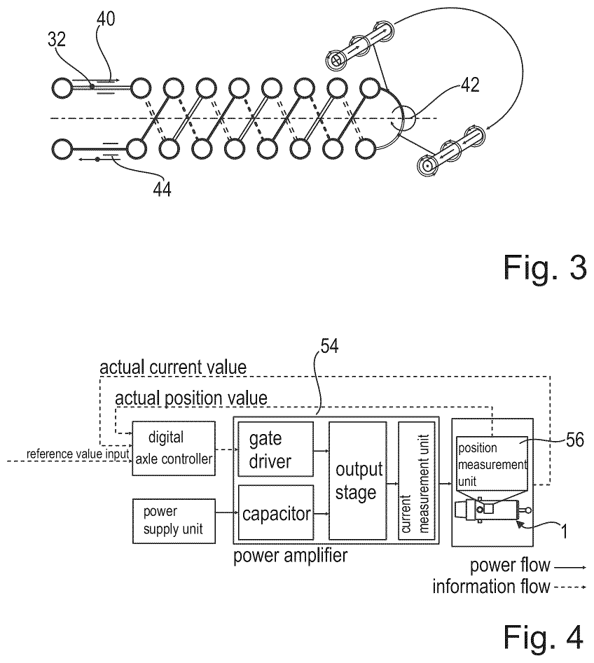

The winding concept is explained once again by means of the schematic diagram in FIG. 3, wherein the coil 32 is shown offset by 180° against the representation in FIG. 2.

Accordingly, the coil 32 enters into the area of the coil holding section 26 via the indicated coil inlet 40 and then extends spirally up to the indicated turning point 42. In doing so, said coil area follows the geometry of the spiral groove 28 not visible in FIG. 3. The coil 32 then extends away from the turning point 42 toward the coil outlet 44, said coil section of the bifilar winding extending along the further spiral groove 30 (not shown in FIG. 3, either).

Indicated on the right in FIG. 3 are the magnetic fields which occur in the coil section extending toward the turning point 42 (at the top right in FIG. 3) and in the coil section extending away from the turning point 42 (on the right in FIG. 3). It is obvious that—as above described-said magnetic fields concentrate in the area of the webs due to the bifilar winding and there occurs approximately no magnetic flux that flows through geometrically larger areas than the webs themselves.

The basic structure of the above-mentioned power electronics 54 is shown in FIG. 4. FIG. 4 only shows the principle of a possible regulation; FIG. 11 constitutes the structure of the control. It should be noted that, due to the geometrically optimized shaping of the drive components and the rather unusual single-phase configuration, the force density is maximized, which in turn enables high-frequency activation of the coils 32 and, accordingly, minimum cycle times of the system. The accompanying high current intensities with a simultaneously high switching frequency cannot or can only be generated with great difficulty by conventional servo amplifiers. Accordingly, the power electronics 54 shown in FIG. 4 is optimized with respect to the control of the linear actor according to the invention. For setting up the power electronics 54, partly standard modules such as a digital signal processor for implementing the necessary arithmetic operations, sensory components for position measurement and transducers for voltage supply can be used. The applied digital signal processor, as an integrated logic unit, processes the incoming and outgoing signals and controls the drivers of the power electronics 54. The dedicated software for the digital signal processor incorporates the complete circuit logic of the actor unit and has to transmit switching information appropriately to a driver stage. The power electronics 54 in this example is designed for the application of machine hammer peening. In the shown embodiment, the maximum voltage amounts to approximately 100 V, wherein the system in its current version is operated between 40 and 60 V. All measured values and reference value inputs are forwarded to the axial controller/axial regulator based on a digital signal processor which, thus, assumes a role as a central logic unit. The connected driver stage has the function to prepare the logic signals of the digital signal processor for the control of the power transistors in the output stage. Accordingly, the achievable dynamics of the switching operation are important, as the resulting switching time of the output stage has a substantial effect on the total performance to be expected. The output stage is designed so that the required fluxes can be switched by an inductive load with high dynamics. According to one embodiment, the required electrical energy is made available via an appropriately dimensioned capacitor. The energy can also be supplied directly via the power grid. Said capacitor is to have a minimum parasitic inductivity to prevent the rise time of the current at the switch-on time from being negatively affected. The current which finally flows to the linear actor is defined by the duty cycle of the coil voltage, the characteristics of the winding and the total inductivity of the system. The system can be operated, in the control operation, via the specification of a voltage value over a defined period of time. In addition, it is also possible to convert the values from the distance measurement to a vector quantity of speed and to use the same as a measured variable for the controlled operation in order to regulate the speed and, thus, the available kinetic energy via the duty cycle of the system.

A position measurement unit transmits a signal to the power electronics 54 which herefrom determines the exact position and speed of the rotor 24.

The power electronics 54 further allows communication with a machine tool/robot control so that the surface hammer 1 can be guided along the desired trajectory for machining the workpiece and can be triggered at the intended positions.

At the top of FIG. 5, the home position of the linear actor 6 according to the invention, more precisely the position of the rotor 24 relative to the stator 18, is shown in a strongly simplified manner. In said home position which is adjustable, for example, by a bias of the rotor 24 (i.e., adjustable via the guides distributed along the circumference [serving as an anti-twist protection, guide of the springs and end position of the rotor]), the helical rotor webs 50, 52 delimiting the rotor grooves 46, 48 are offset against the groove webs 34, 35 which delimit the two spiral grooves 28, 30 so that there is a maximum offset 58 between said rotor webs 50, 52 and the groove webs 34, 35. (Note the following relation: offset≤web width). In this initial position, the rotor webs 50, 52 and the groove webs 34, 35 are arranged to be offset against each other by about a width of said webs. This offset corresponds, in the shown embodiment, to the maximum stroke of the linear actor 6 which may be 1 mm, for example. In this home position, the minimum total inductivity of the whole system is provided, the magnetic resistance, on the other hand, is the greatest. If a voltage is applied to the coil 32, as indicated at the bottom of FIG. 5, a current flow occurs in the bifilar winding which changes its direction at the turning point 42 and, thus, also influences the magnetic field formed. Accordingly, when applying the electric voltage, the coil 32 generates a magnetic field between the adjacent pairs of pole shoes which are formed by the groove webs 34, 35 and rotor webs 50, 52 facing each other, said magnetic field being formed corresponding to the current direction. In the two representations according to FIG. 5, the resulting field lines are plotted. Further, the linear actor 6 includes a position sensor (not shown) which measures/detects the stroke of the rotor 24 over time.

When the d.c. voltage is applied, at the beginning of the control the magnetic resistance is maximum—as explained above—which is illustrated by the comparatively largely spaced field lines at the top of FIG. 5. Since, when the coil 32 is energized, the system tends to a minimum magnetic resistance (reluctance), and in the shown initial position (top of FIG. 5) the highest magnetic resistance is effective, a reluctance force is created that acts on the rotor 24 in the direction of the minimum magnetic resistance which results when the rotor webs 50, 52 are overlapped by the groove webs 34, 35. A reluctance force plotted in FIG. 5 is created in the axial direction F_{R} which is comparatively high due to the reluctance-optimized web geometry.

As is shown in the representation according to the top of FIG. 5, in the area of the outlet surface of the magnetic flux a deflected magnetic flux occurs on the stator side. Said deflection also depends, apart from the geometrical constraints such as the design of the tooth geometry on the rotor and stator sides, substantially on the offset 58. When the coil 32 is energized, the ideal position regarding the reluctance between the stator 18 and the rotor 24 results in which the overlapping of the groove webs 34, 35 and the rotor webs 50, 52 is maximum and, thus, a substantially homogenous magnetic flux is achieved.

In addition, radial forces which act on the rotor 24 in the radial direction are created—said radial forces are compensated by the bearing, more particularly by a plain bearing.

In the shown embodiment, the plain bearing bushes 20, 22 are designed so that the rotor 24 can be adjusted by the reluctance force FR while the positioning accuracy is high. Said adjustment of the rotor 24 is performed until the relative position is reached in which the minimum magnetic resistance is provided while the total inductivity at the same time is maximum. This state is plotted at the bottom of FIG. 5. Accordingly, said state is achieved with maximum overlap of the groove webs 34, 35 with the rotor webs 50, 52 so that accordingly the maximum field line density is achieved, with the forces acting in the radial direction being maximum and the forces acting in the axial direction being minimum. The radial air gap ΔR remains constant during the entire movement sequence. The offset 58, i.e., the degree of overlapping, the reluctance, the inductivity and the magnetic flux vary with the axial movement 18, however.

As explained in the foregoing, power electronics 54 are required to provide the high performance of the coil 32. In doing so, appropriate measures have to be taken to protect the linear actor 6 from overheating and, thus, from destruction of the drive unit. This can be done, on the one hand, by proper control or regulation via the power electronics and, on the other hand, by additional cooling. FIG. 6 illustrates options for cooling the linear actor 6 according to the invention. Accordingly, for example the area of the linear actor 6 in which the radial air gap AR is formed, as well as the internal stator can be cooled so that coolant flow paths 62, 64 are formed along the stator 18 or the air gap ΔR. It is of particular advantage that, in the described embodiment, the coil 32 is formed by an insulated strand so that direct contact of the live areas of the coil with the cooling medium is excluded. Correspondingly, air or a cooling liquid may be used as a coolant. In the embodiment shown in FIG. 6, in the stator at least one coolant passage 60 is formed through which the coolant flows. Said coolant passage 60 can also be closed on one side, wherein an appropriate backflow of the coolant has to be made possible. It is basically possible to use different coolants for cooling the radial air gap ΔR and for (internally) cooling the stator 18.

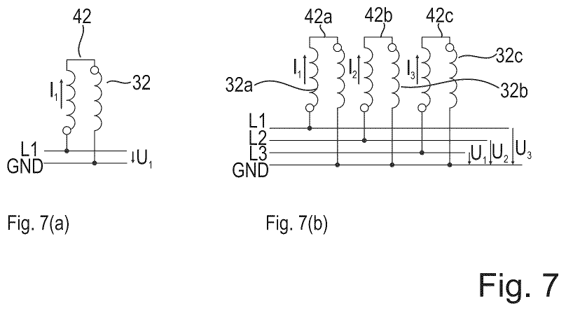

The afore-described embodiment is a single-phase system—the corresponding switch symbol for the coil is shown in FIG. 7a. That is, current is supplied via the current supply L1, wherein, in the area of the coil 32 leading to the turning point 42, the current direction is opposite to that in the coil section extending from the turning point 42 to the coil outlet and, thus, to the negative pole of the system.

Such a single-phase system is excellently suited for a short-stroke movement, the maximum stroke corresponding—as explained above—approximately to the width of those webs 50, 52; 34, 35. As a matter of course, in the case of a smaller axial offset, the stroke can also be smaller. According to the invention, each of the pairs of pole shoes is formed by a continuous helix with a predetermined pitch and a predetermined tooth geometry (tooth length and tooth width in cross-section).

FIG. 7b illustrates an n-phase drive system, concretely a three-phase drive system, in which three coils 32a, 32b, 32c can be activated via the power electronics 54 in order to realize a stroke, for example, that is larger than the width of the above-mentioned webs 50, 52; 34, 35.

Alternatively, or additionally, a bidirectional operation can also be ensured by such multi-phase arrangement without a mechanical reset (via a spring, for example).

In such embodiment, correspondingly the stator 18 then would be designed to have at least two coils 32a, 32b, wherein the latter can be designed to be offset against each other in the axial direction or else to be partly overlapping in a respective bifilar winding. It should be noted that two coils appear sufficient to ensure a bidirectional operation.

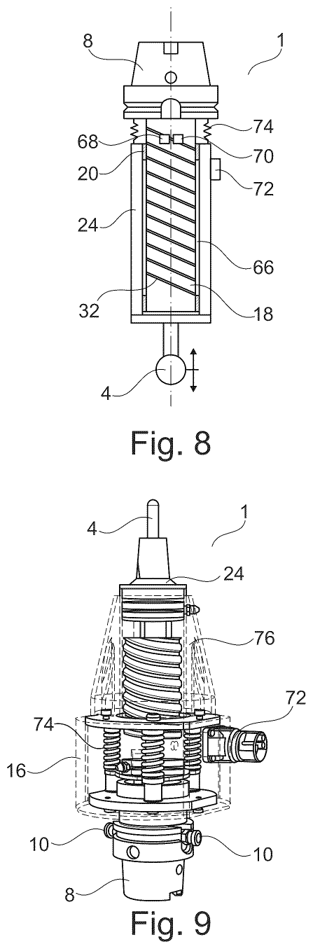

FIG. 8 illustrates a schematic lateral section view of the linear actor 6 according to the invention which includes a hammer head 4 made of carbide or any other materials which is subjected to periodic oscillations or discrete single impact movements, or can be kept in continuous contact with the workpiece to be machined by means of a linear actor 6 for machine hammer peening according to the invention. The surface hammer 1 further has a mechanical interface, in the present case a hollow-shank taper 8, via which the surface hammer 1 can be inserted into a suitable tool holder of a machine tool or a robot so that the surface hammer 1 is guided over the NC axes of the machine tool or the robot during machining. The rotor 24 is arranged relative to the stator such that an air gap 66 is provided between the two elements. In addition, the linear actor 6 includes a temperature sensor and a distance measuring sensor/position sensor 70. In this shown view, a (combined) data and performance bush 72 is arranged on the side of the linear actor 6. Furthermore, plural resetting elements 74, in the form of return springs, are arranged between the rotor 24 and the hollow-shank taper 8 to reset the rotor 24 into a predefined initial position (after a stroke operation). Accordingly, the resetting elements 74 are arranged along the circumference of the stator 18.

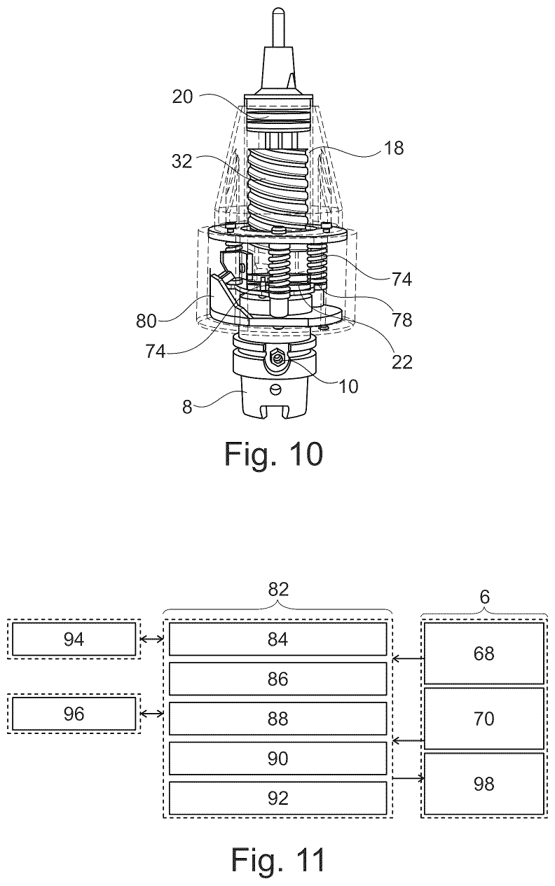

FIG. 9 and FIG. 10 illustrate an isometric front view and/or rear view of the linear actor 6 according to the invention of the surface hammer 1 of the embodiment shown in FIG. 8. In this representation, the linear actor 6 includes additional (coolant) ports 10 which are arranged facing each other on the sides of the hollow-shank taper 8. The plurality of resetting elements 74, in the form of return springs in this case, which are arranged between and tightly connected to two opposite rings are clearly visible. The coil 32 is arranged/wound around the stator 18. The rings, in turn, are tightly connected to the rotor 24. Moreover, the rotor 24 includes a rotor sleeve 76 (shown transparently here) which opens into the housing 16 of the linear actor 6. Two plain bearings 20, 22 are arranged at the respective ends of the rotor 24. The plain bearing 22 that is arranged at the end of the hollow-shank taper 8 includes an additional bearing maintenance element 78. Furthermore, a measurement system 80 is shown which detects the deflections/positions of at least one resetting element 74/change of position of the rotor 24.

FIG. 11 illustrates a schematic functional representation of the regulation unit 82 of the linear actor 6. The regulation unit 82 comprises a D/A (digital-analog) input and output 84, an interface 86, a control unit 88, a power stage 90 as well as a power supply unit 92. A first communication interface of the actuator regulation forms a serial interface which is optionally implemented via an NC control 94 or an HMI (human-machine interface) 96 such as a PC or a tablet. Accordingly, the machining parameters such as impact time, intensity and/frequency are determined and transferred to the control unit 88. The regulation unit 82 analyzes the values detected by the temperature sensor 68 and the position sensor 70 of the actuator 6 and transmits the electrical power 98 depending thereon to the linear actor 6. Thus, the hardware interface 6 between the regulation unit 82 and the linear actor 6 (shown on the right here) transmits the digital and/or analogous signals such as temperature and path data as well as the electrical power.

In contrast to the above-described prior art in which at least two circular pairings of pole shoes are formed between the stator and the rotor, in accordance with the invention a helical pair of pole shoes is formed between the stator and the rotor to which a coil with a bifilar winding is assigned according to the invention.

The above-described invention basically excels by an extremely robust design of the coil/winding so that impacts and vibrations can be compensated in a definitely better way than in prior art.

As afore-mentioned, a scaling with respect to the achievable force or else the stroke is possible more easily by the bifilar winding design than in conventional solutions. Also, cooling of the coil can be realized by far more easily as the stator is cooled hydraulically, for example, and the insulated winding between the stator and the rotor can additionally be air-cooled. This permits an operation with significantly increased current densities. This results in a further increase in the power density and, thus, the capability of acceleration. The design according to the invention having one or more resetting elements 74 enables a continuous and a discrete movement (i.e., triggering of one or more single blows) of the hammer head 4.

The reduction of the inductivity which is increased once again by the bifilar winding enables maximum dynamics when the winding is energized. The bifilar winding further enables the packing density to be further increased and, thus, the specific force of the drive to be increased.

### LIST OF REFERENCE SIGNS

1 surface hammer
2 blow insert
4 hammer head
6 linear actor
8 hollow-shank taper
10 port
12 port
14 port
16 housing
18 stator
20 plain bearing
22 plain bearing
24 rotor
26 coil holding section
28 spiral groove
30 spiral groove
32 coil
34 groove web
35 groove web
36 single wire
38 insulation
40 coil inlet
42 turning point
44 coil outlet
46 rotor groove
48 rotor groove
50 rotor web
52 rotor web
54 power electronics
56 position measurement unit
58 offset
60 coolant passage
62 coolant flow path
64 coolant flow path
66 air gap
68 temperature sensor
70 position sensor/distance measurement sensor
72 data and power bush
74 resetting element
76 rotor cover
78 bearing maintenance element
80 measurement system
82 regulation unit
84 D/A input/output
86 interface
88 control unit
90 power stage
92 power supply unit
94 NC control
96 human-machine interface
98 electrical power

1-15. (canceled)

16. A linear reluctance actor comprising:
an axially adjustable rotor and a stator arranged coaxially thereto, and
at least one coil arranged in the area between the stator and the rotor which is guided in a groove of the stator and which is delimited by groove webs,
wherein a groove profile facing the groove webs is formed on the rotor, the groove walls forming an offset with each of the groove webs, and comprising power electronics for activating the at least one coil such that the rotor performs a controlled/controllable stroke due to the reluctance force in response to the activation,
wherein the groove profile is designed to be complementary to the groove webs so that they are arranged to be approximately radially opposite to each other with a minimum offset,
wherein the stator and the rotor are made of a magnetically conductive and/or soft magnetic material, and
wherein the linear actor includes at least one resetting element which is designed in such a manner that during operation the rotor is brought into a specific predefined initial position after a stroke movement.

17. The linear actor according to claim 16, wherein the at least one resetting element is designed to be resilient in the movement direction of the rotor and/or a plurality of resetting elements are distributed along the circumference of the stator.

18. The linear actor according to claim 16, wherein each of the groove and/or the groove profile is in the form of a double helix,
wherein the coil is guided along a helix turn from a coil inlet to a turning point and from there along a second helix turn in the opposite direction back to a coil outlet so that the coil sections guiding to and away from the turning point are arranged to be bifilar.

19. The linear actor according to claim 16, wherein the rotor is tubular and encompasses the stator,
wherein the grooves guiding the at least one coil and being in the form of a double helix are formed on an outer circumferential surface of the stator and the associated groove profile equally in the form of a double helix is formed on an inner circumferential surface of the rotor.

20. The linear actor according to claim 16, wherein the coil is designed as a stranded wire consisting of a plurality of single wires or as a single wire having plural turns.

21. The linear actor according to claim 16, wherein the coil is insulated.

22. The linear actor according to claim 16, wherein plural coils are connected to form a multi-phase structure and can be individually activated via the power electronics so that the stroke of the rotor is increased vis-à-vis a single-phase structure, or a bidirectional operation is made possible.

23. The linear actor according to claim 16, further comprising a cooling assigned to the at least one coil.

24. The linear actor according to claim 23, wherein the cooling is carried out by means of a coolant, such as air or a cooling liquid, which is guided along an air gap and/or the stator.

25. The linear actor according to claim 16, wherein pitches and groove widths of the stator-side and rotor-side double helix are substantially equal.

26. The linear actor according to claim 16, wherein the linear actor includes at least one resetting element in the form of a return spring.

27. The linear actor according to claim 16, wherein the linear actor includes a plurality of resetting elements distributed along the circumference of the stator in the form of return springs which are configured so that during operation the rotor is brought into a specific predefined initial position after a stroke movement.

28. A tool comprising the linear actor according to claim 16, wherein a tool holder for a hammer head is provided on the linear actor, and further comprising a machine tool interface, such as a hollow-shank taper for an HSK tool holder of a machine tool or a robot.

29. A valve drive for actuating servo and/or directional valves comprising the linear actor according to claim 16.

30. A valve drive of an internal combustion engine comprising the linear actor according to claim 16.

31. The linear actor according to claim 16, wherein the linear actor comprises a position sensor, which is configured to measure a stroke of the rotor over time.
